(19) United States
(12) Patent Application Publication
(10) Pub. No.: US 2011/0013351 A1
(43) Pub. Date: Jan. 20, 2011

(54) PORTABLE MONITOR

(75) Inventors: Jeffrey J. Simmons, Needham, MA (US); Lawrence M. Pensack, Newton, MA (US); Frederic A. Macdonald, Santa Monica, CA (US)

Correspondence Address: SAND & SEBOLT, AEGIS TOWER, SUITE 1100, 4940 MUNSON STREET, NW, CANTON, OH, 44718-3615, US

(73) Assignee: MOBILE MONITOR TECHNOLOGIES, LLC, Newton, MA (US)

(21) Appl. No.: 12/832,448

(22) Filed: Jul. 8, 2010

Related U.S. Application Data
(60) Provisional application No. 61/226,759, filed on Jul. 20, 2009.

(51) Int. Cl. G06F 1/16

(52) U.S. Cl. 361/679.27

(57) ABSTRACT

Methods, apparatus and other embodiments associated with a portable monitor are presented. The portable monitor includes a monitor base with a rear support brace on the bottom of the monitor base. The portable monitor includes a monitor device with a video screen. The video screen can display video data received from a device external to the portable monitor. A universal hinge connects the monitor base to the monitor device. The universal hinge can position the monitor base and the monitor device in a closed position, an open position and a tablet position. In the tablet computer position the monitor device is folded against the monitor base with the video screen facing away from the monitor base. The rear support brace can be extracted from the monitor base to support the portable display in substantially vertical position when the portable display is in the tablet computer position.

### CROSS REFERENCE TO RELATED APPLICATIONS

This application claims priority from U.S. Provisional Application Ser. No. 61/226,759, filed Jul. 20, 2009, the disclosure of which is incorporated herein by reference.

### BACKGROUND OF THE INVENTION

1. Technical Field

The present invention relates generally to apparatus and systems related to computer monitors. More particularly, the apparatus and systems relate to portable computer monitors. Specifically, the apparatus and systems of the present invention involve a portable computer monitor with a universal hinge and a rear display stand.

2. Background Information

The computation speed and the amount of memory in computers have been dramatically increasing for the past several years. These increases allow a user to increase the number of programs that can be simultaneously run on a single computer. Simultaneously running programs each often generate a separate “window” displayed on a monitor. Similarly, a single program can open several documents or files simultaneously into different windows on the display.

While computers can easily handle the display of multiple windows, the space on a monitor for displaying multiple windows is limited. Windows may be partly or completely overlapping. The user may have to switch between windows. In many instances, it would be more efficient for the user to view two or more windows simultaneously. While the windows can be tiled on the monitor, the size of each window is reduced and may not easily be viewed. One solution is to develop larger monitors that have substantially larger display areas. While these monitors are capable of displaying more windows simultaneously, they generally require more desk space, are heavy and not easy to move around (and are thus more permanent) and are costlier to produce.

Multiple monitors can be used to create a greater area to display windows. Dual monitor systems can be enabled to display multiple windows in each display. In the dual monitor systems, a secondary display controller and associated display are interfaced to the computer in parallel with a primary display controller and associated display. Graphical user interface (GUI) software is commercially available that controls the dual monitors so that the monitors appear as a single correspondingly larger virtual display system, so that curser manipulations and data entry move from screen to screen in a natural manner. For example, one display can display active data entry, while the other can display static reference data such as help screens or other screens. Current operating systems used in personal computers can accommodate multiple monitors.

### BRIEF DESCRIPTION OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a perspective view of the preferred embodiment of a portable monitor.

FIG. 2 illustrates a top view of the preferred embodiment of the portable monitor.

FIG. 3 illustrates a rear view of the preferred embodiment of the portable monitor.

FIG. 4 illustrates the rotation of the screen of the portable display.

FIG. 5 illustrates another rotation of the screen of the portable display.

FIG. 6 illustrates the fully rotated screen with the portable display in the tablet position.

FIG. 7 illustrates the fully rotated screen with the portable display in an upright position.

FIG. 8 illustrates a rear view of the fully rotated screen with the portable display in an upright position.

FIG. 9 illustrates a method of producing a portable display.

Similar numbers refer to similar parts throughout the drawings.

### DETAILED DESCRIPTION

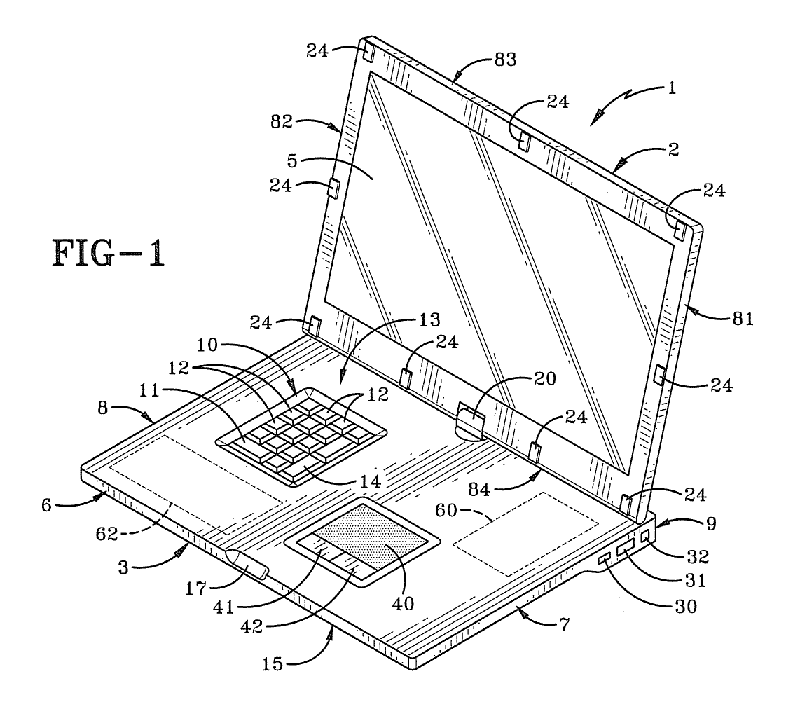

FIG. 1 illustrates a preferred embodiment of a portable monitor 1 that can be connected to a computer as a second monitor. The portable monitor 1 includes a screen device 2 attached to base 3 with a universal hinge 20 (e.g., compound hinge). The base 3 forms a housing that is used to support the screen device 2. The base 3 can be formed similar to housing used in a traditional laptop computer. The base 3 should be shaped and have enough weight to support and balance the screen device 2 when in the open position as shown in FIG. 1. The base 3, screen device 2, and other components of the portable monitor display are generally formed with rigid plastic or other polymer based materials or a metal such as aluminum, but other materials can be used. The base 3 and screen device 2 are generally formed as complementary rectangular shapes with the base 3 having a right side 7, a left side 8, a front side 6, a back side 9 and a bottom surface 15. The screen device 2 has a right side 81, a left side 82, a top side 83 and a bottom side 84. As discussed later, a universal serial bus (USB) port 30, a video input port 31 and/or a jack 32 can be placed in the right side 7 of the base 3. Alternatively, these ports or other auxiliary ports 33, 34, 35 can be placed in the left side 8 of the base 3. For example, port 32 can be a power input plug, port 31 can be a USB-B port and port 30 may be a power on/off switch. Even though the figures illustrate one portable monitor 1, multiple portable monitors could be daisy changed together with one host computer.

In a traditional laptop computer the housing would include a mother board, disk drives, a power supply, and other computer components and electronics. Unlike a traditional laptop computer, the base 3 of the preferred embodiment may contain electronic components for operating a display screen 5 located in the screen device 2, but generally does not include a motherboard or central processing unit (CPU), disk drives, and other computer components. Because the mobile monitor 1 has fewer components than a traditional computer, it can be produced much more economically than a full computer. The display screen 5 can be 15.4″, 15.6″ or a different size.

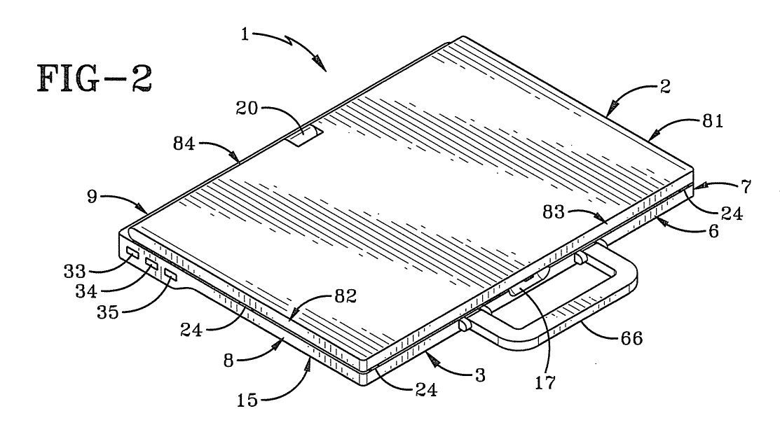

The screen device 2 (e.g. upper portion) and base 3 (e.g. lower portion) are similarly sized so that they can be folded together similar to a laptop computer in a closed folded position shown in FIG. 2. In this position, the portable display can be transported without scratching the display screen 5. In this position the portable monitor 1 is easily transportable, for example, with a laptop in a laptop carrying case or bag. Typically the connection between the base 3 and screen device 2 provides sufficient friction to temporarily keep the base 3 and screen device 2 in the closed position. If necessary or desirable, the portable monitor 1 may further comprise at least one latch 17 in the front side 6 of the base 3 to temporarily keep the base 3 and screen device 2 in the closed position. Alternatively, a recessed area can be formed near the latch 17 or the recessed area can be used to aid in the opening of the portable monitor 1 with or without the latch 17. Similarly, it is possible but not required to have at least one handle 66 (seen in FIG. 2) attached to the portable monitor 1 at either the base 3 and screen device 2, or both.

The screen device 2 and the base 3 are connected together with a universal hinge 20 attached to the bottom side 84 of the screen device and the base 3 that also allows the portable monitor 1 to be configured into a tablet display as discussed later. The screen device 2 generally surrounds the display 5 to protect the display from scratching or damage while the portable monitor 1 is transported.

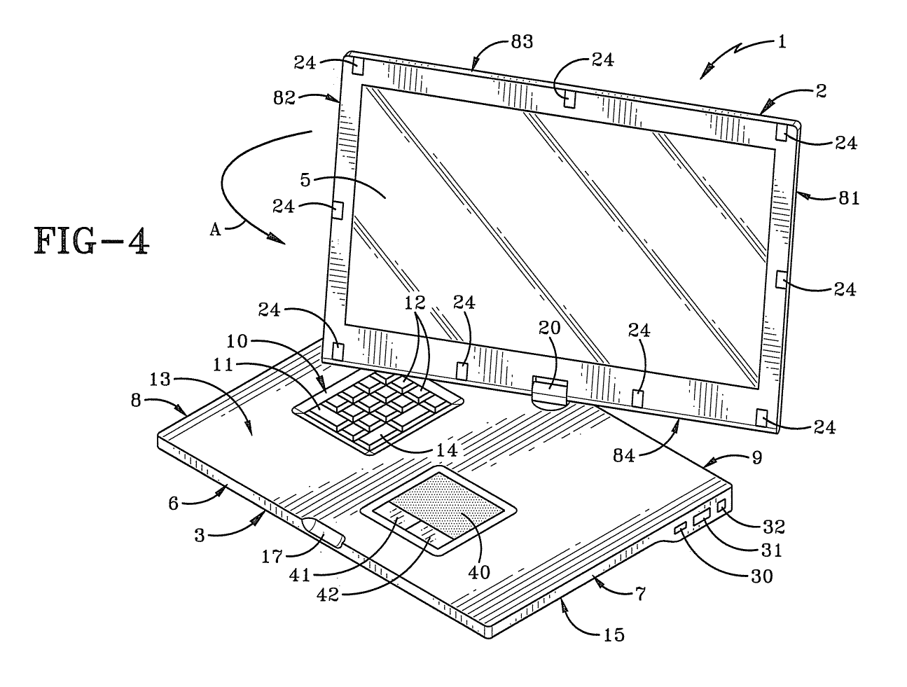

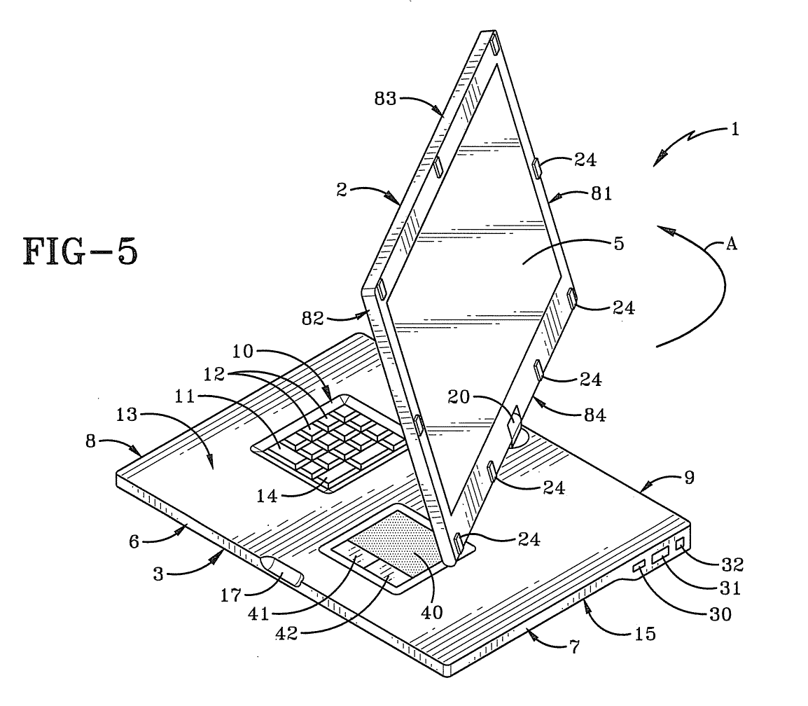

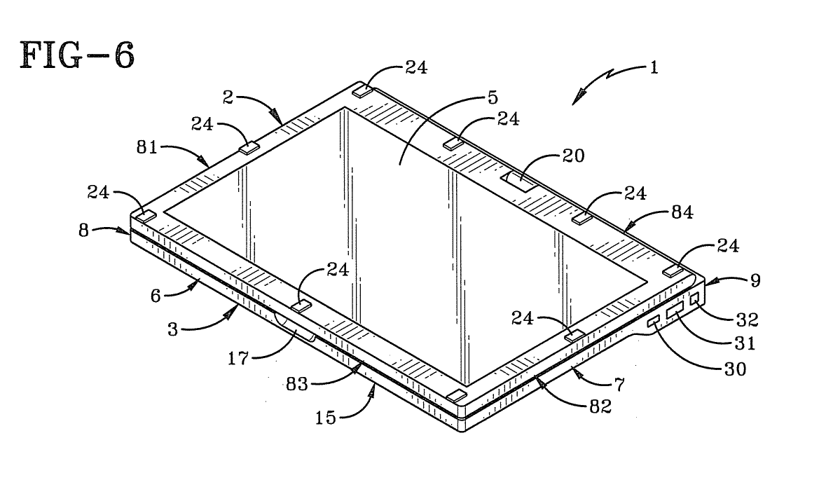

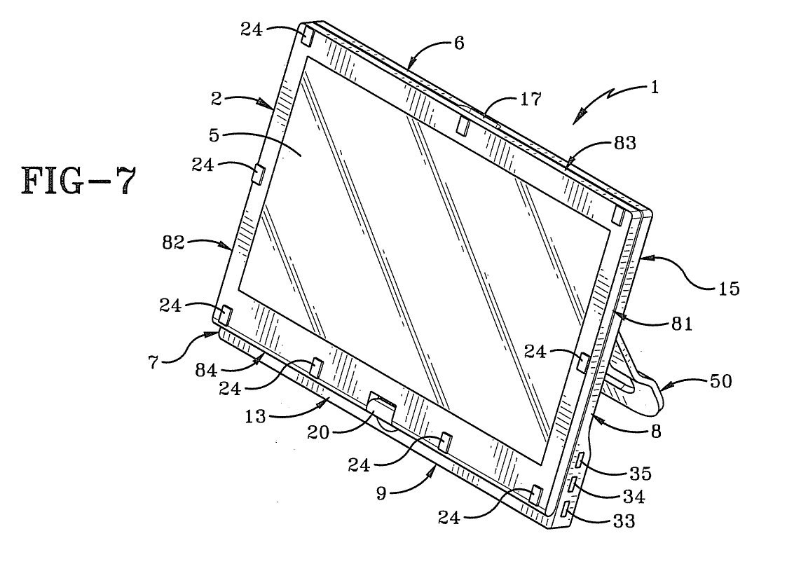

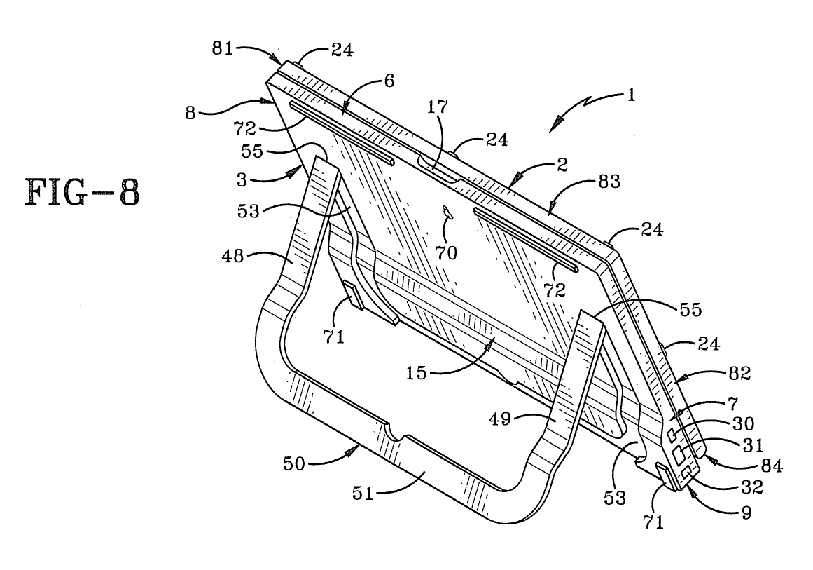

The base 3 also includes a U-shaped rear support brace 50 as shown in FIGS. 7 and 8. The rear support brace 50 includes a left arm 48, a right arm 49 and a center support beam 51 positioned between the left and right arms 48, 49. In the “laptop display position” of FIG. 1, the rear support brace is folded under the base 3 and not used because the base 3 acts to support the screen device. However, as shown in FIGS. 4 and 5, the screen device 2 can be rotated about the universal hinge 20 in the direction of arrow A and then folded into a tablet type of display position as shown in FIG. 6. Of course, the Universal hinge 20 can allow the screen device 2 to be rotated in directions different than what is shown by arrow A in the figures. In some embodiments, the hinge 20 may only rotate in one direction. In the tablet position, the right side 81 of the screen device 2 is adjacent to the left side 8 of the base 3. Similarly, the left side 82 of the screen device 2 is adjacent to the right side 7 of the base 3 in the tablet position. In this position, the portable monitor 1 can rest on a desktop surface and be used as a tablet display. Alternatively, the rear support brace 50 can be extracted from the bottom surface 15 of the base 3 so that the portable monitor 1 can be tilted forward and used as an upright monitor as shown in FIGS. 7 and 8. The rear support brace 50 may be pivotally attached to the bottom surface of the base 3 at each end of the rear support brace 50 at two pivot points 55. The pivot points 55 may comprise two pins, hinges, or other pivot mechanisms as understood by those of ordinary skill in the art. The base 3 may have a recessed area 53 that the support brace 50 can be folded into.

In another configuration of the preferred embodiment, the base 3 may include one or more devices for inputting data into a computer the portable monitor 1 is connected to. For example, the portable monitor 1 can include a keypad 10 for entering data into the display. The keypad 10 can include numerical keys 12 for entering numerical digits into the portable monitor 1 and into a computer the portable monitor 1 is connect to. The keypad 10 can include an “enter” button 14 for indicating an entire number is ready to be entered or another function is ready to be performed. The keypad 10 may include other buttons such as one or more function buttons 14 that indicate to a computer that a certain function is to be performed when the function button is pressed. Other input devices that can be used with portable monitor 1, whether incorporated into the base 3 or otherwise connected to the portable monitor 1, include a full QWERTY keypad, a joy stick, a touch screen, an electronic pen, speakers, or no other device (e.g., a base 3 with no openings). The portable monitor 1 can be connected to and controlled by cell phone such as a Blackberry, iPhone or another electronic device.

The portable monitor 1 can be configured with a full QWERTY keypad and mouse for use by an individual student in a classroom setting. The portable monitor 1 can be linked to a host computer and act as a “zero client”. Alternatively, the monitor 1 can be daisy chained with other portable monitors 1 or input directly to a host computer. This allows students to log into personal accounts on the host computer, and enter data through the portable monitor 1 which is transmitted, stored, and processed on the host computer. This allows a single classroom to have one host computer and 20 or more “zero client” devices such as portable monitors 1.

In one configuration of the preferred embodiment, as shown in FIG. 1, the base 3 of the portable monitor 1 may include a touchpad 40 (e.g., trackpad) that is a tactile type of sensor. The touchpad 40 can be configured to track the position of a user's finger to position a corresponding curser on the monitor screen 5. The touchpad 40 may be associated with one or more enter 41 and/or select keys 41, 42. These keys 41, 42 may correspond to the left and right mouse keys of a traditional mouse. Traditional laptop computers have a limited area for keys and often only have a basic QWERTY keypad. However, when the portable monitor 1 is attached to a computer, the portable monitor 1 can include the keypad 10, the touchpad 40 or other input devices to enhance the input capabilities of a traditional mobile computer.

The portable monitor 1 will typically need a source of electrical power. Either a conventional external or internal 120 VAC (or equivalent) power supply may be included that is transformed to a desired voltage, or a battery 60 may be located within either or both of the base 3 and screen device 2. As is well known in the art, both rechargeable batteries 60 and a connection to an external power source for charging the batteries 60 and/or powering the display may be employed. It is preferred to place any power-related components within the base 3 so that the weight of such components may add stability to the portable monitor 1 when it is in an open position. It is also possible for the portable monitor 1 to have conventional battery “bays” that accommodate removable batteries 60, either alone or in combination with an external power supply as is common in the art.

The portable monitor 1 also includes a video input port 31 in the right side 7 of the base 3 that is used to receive video data to be displayed on the screen 5. The video input port is capable of receiving audio/video data as well as video data. The portable monitor 1 can be configured to receive one or more formats of video data and to display the video data onto the screen 5. The video data may be in an analog format or a digital format. The video input port 31 can be connected to one end of a suitable cable and the other end of the cable can be connected to another device such as a laptop that is generating the video data to be displayed on the portable monitor 1. One type of cable that may be used for connection to a common laptop computer is a conventional video graphics array (VGA) cable or super VGA (SVGA) cable. Other kinds of audio/video input ports 31 can be used that can connect to other cables such as mini-DIN cables (Deutsches Institute for Normung standard cables), RCA cables, mini-VCA cables, DisplayPort cables, Mini-DisplayPort cables, USB cables and other types of cables. In another configuration of the preferred embodiment, the portable monitor 1 includes a receiver to wirelessly receive audio/video data for display on the screen 5. The portable monitor 1 can receive video data from a variety of electronic devices including computers such as laptop computers, table computers, notebook computers, personal computers, personal digital assistants (PDAs), cellular telephones, internet terminals, gaming devices, personal music or video devices, and other devices that generate video data. In another configuration, the portable monitor 1 can have the capability of sending and receiving wireless data (e.g., numeric and text data entered from the numeric keypad and/or QWERTY keyboard).

In one configuration, the preferred embodiment can include a power saving logic configured to determine if an image displayed on the screen has not changed in a time period. The power saving logic can then cause the portable display to enter a low power mode when the image displayed on the screen has not changed for the time period. For example, the power saving logic can dim the screen 5 to save power. Later, the power saving logic may detect the image displayed on the screen 5 is changing and may apply additional power to the screen.

In another configuration, the portable monitor 1 contains a DisplayLink chip. Of course, those of ordinary skill in the art will appreciate that other chips can be used for controlling and operating the monitor 1. Software that accesses the chips can allow a user to rotate images on the portable monitor 1 to be vertical or “mirror” mode images. The software further has the ability to remember the display configuration as well as previous settings. This allows a user to disconnect the portable monitor 1 from a computer and then later reconnect it to the same computer so that the chip in the portable monitor 1 will remember previous display settings. The DisplayLink chip has controls for adjusting color, resolution, etc which can be accessed through a DisplayLink manager menu. This chip can also implement power saving features to conserve battery life. When a host computer the portable monitor 1 is connected to goes to sleep, the chip senses that and makes similar changes to the portable monitor 1.

In other configurations, the preferred embodiment can include other useful features. For example, the portable device can include controls for adjusting the visual quality (color balance, hue, intensity, and the like) of an image on the screen 5. The image quality may be adjusted by manipulating one or more of the keys 11, 12, 14 on the keypad 10 or via controls 35. In some configurations, the portable monitor 1 can include one or more speakers for generating sound that may be associated with data displayed on the screen 5. Alternatively, the portable monitor 1 can include a jack 32 to connect to an external speaker. The portable monitor 1 may also include an auxiliary connector such as a universal serial bus (USB) to allow a mouse or another device to be connected to the portable monitor 1. Air vents 57 may also be formed in the portable monitor 1 if there is a need for cooling the portable monitor 1. Rubber pads 24 may be placed on the screen device 2 to cushion the screen device 2 onto the base 3 as it is folded onto the base 3 in the closed position. Rubber pads can also be added to the base 3 to protect the back of the screen device 2 when the portable monitor 1 is in the tablet computer position. The portable monitor 1 may include a chamber 62 in the base 3 that allows an electrical cable to be stored in the base 3. The electrical cable can be used to connect the portable monitor 1 to a computer or other electronic device. The bottom surface 15 of the base 3 may include rubber or other polymer pads 71, 72 attached to the base to prevent the sliding of the portable monitor 1 when it is resting on a surface in the tablet, open laptop or closed positions. The bottom surface 15 may also contain one or more openings 70 to allow the portable monitor 1 to be mounted on a vertical surface such as a wall. The portable monitor 1 can have openings to attach a cable locking device such as a Kensington type of lock. The portable monitor 1 may contain other useful devices such as a built in video camera for video conferencing (e.g., Skype), a built in camera, or other device.

Example methods may be better appreciated with reference to flow diagrams. While for purposes of simplicity of explanation, the illustrated methodologies are shown and described as a series of blocks, it is to be appreciated that the methodology is not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

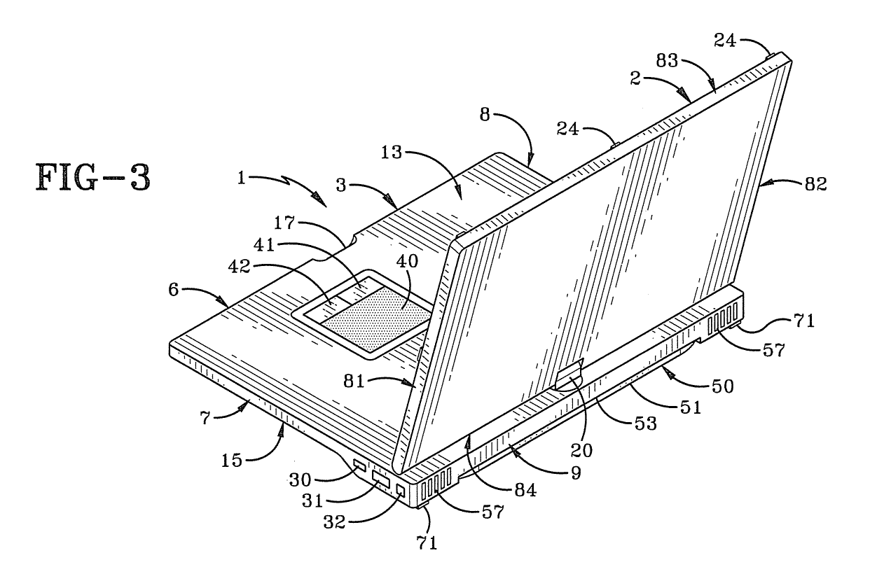

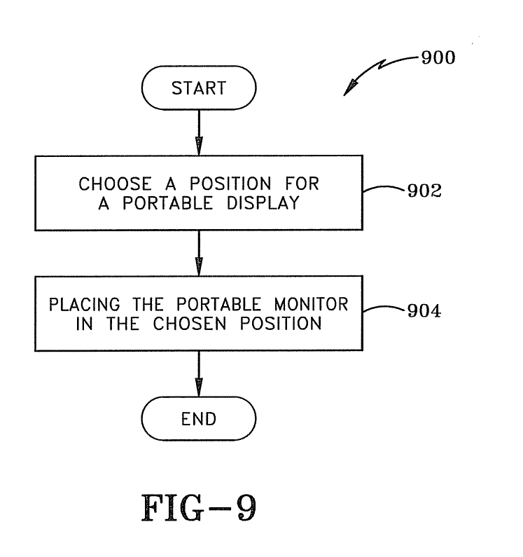

FIG. 9 illustrates a method 900 of using a portable display comprised of a monitor and a base. The portable display can lack a processor executing software instructions. In one configuration, the portable display can include a DisplayLink chip to process image data. The method 900 chooses, at 902, whether to place the portable display in a closed laptop position as shown in FIG. 2, an open laptop position as shown in FIGS. 1 and 3, a tablet computer position as shown in FIG. 6 or a freestanding monitor position as shown in FIGS. 7 and 8.

A universal hinge is connected to the base and monitor to orientate the portable display to be displayed in a closed laptop position, an open laptop position, a tablet computer position, or a freestanding monitor position. The monitor is planar and adjacent to the base with the display screen facing toward the base when the portable display is in the closed position. When the portable display is in the closed position, the base is generally horizontal to a horizontal surface and the monitor is opened away from the base to allow a user to view the display screen. The display is planar and adjacent to the base with a display screen facing outward from the base when the portable monitor is in the tablet position. The tablet computer position may be a traditional tablet computer position where the display is placed flat on a desk. Alternatively, the tablet computer position may be upright with the display leaning back on a stand supporting the display upright. The monitor and the base are placed, at 904, in the chosen position.

A display stand is pivotally attached to the display base, at 908. The display stand can be attached to the display base and may fold into or away from the base. The display stand can be U-shaped and can be pivotally attached to the two ends of a U-shaped display stand. The display stand can be pivoted from the display base to support the portable display in an upward position when the portable display is in the tablet position.

Different modules can be attached to the display or swapped with other modules attached to the display. For example, different data entering devices can be attached to the display such as a numeric keypad, a full QWERTY keyboard for operation in a classroom/“zero client” setting.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A portable monitor comprising:
a monitor base;
a monitor device including a video screen, wherein the video screen is configured to display video data received from a device external to the portable monitor;
a universal hinge connecting the monitor base to the monitor device, wherein the universal hinge is configured to position the monitor base and the monitor device in a first position that is a closed position with the video screen facing the monitor base, wherein the universal hinge is configured to position the monitor base and the monitor device in a second position that is an open position with the monitor device opened away from the monitor base so that the video screen is in a position for viewing by a user of the portable monitor, and wherein the universal hinge is configured to position the monitor base and the monitor device in a tablet computer position with the monitor device folded against the monitor base with the video screen facing away from the monitor base for viewing by a user of the portable monitor; and
wherein a rear support brace is carried by the portable monitor to support the portable display when the portable display is in the tablet computer position.

2. The portable monitor of claim 1 wherein the portable monitor is free of a primary processor.

3. The portable monitor of claim 1 wherein the portable monitor is free of a processor that executes software instructions.

4. The portable monitor of claim 1 wherein the base further comprises:
a keypad.

5. The portable monitor of claim 4 wherein the keypad is a numeric keypad free of alphabetical keys.

6. The portable monitor of claim 4 wherein the keypad is configured to adjust an image quality of an image displayed on the video screen.

7. The portable monitor of claim 1 further comprising at least one of the group of:
a touchpad for moving a pointer on the video screen, a QWERTY keyboard, a gaming joy stick, a multi-touch base, a video camera, an electronic pen, a cellular telephone connection port, and speakers.

8. The portable monitor of claim 1 wherein when the portable monitor is in the open position the monitor device is in an open laptop computer position.

9. The portable monitor of claim 1 further comprising:
a port in the monitor base port configured to receive video data to be displayed on the video screen from a remote device.

10. The portable monitor of claim 1 wherein the rear support brace is U-shaped.

11. The portable monitor of claim 1 wherein the monitor base further comprises:
a chamber configured to store a cable within the chamber.

12. The portable monitor of claim 1 further comprising:
a handle attached to portable display allowing a user of the portable display to carry the portable display by the handle.

13. The portable monitor of claim 1 further comprising:
a power saving logic configured to determine an image displayed on the screen has not changed in a time period and configured to cause the portable display to enter a low power mode when the image displayed on the screen has not changed for the time period.

14. A portable display comprising
a monitor configured to display video images;
a base attached to the monitor and configured to support the monitor; and
a numeric keypad in the base lacking alphabetical keys.

15. The portable display of claim 14 wherein the portable display lacks a central processing unit (CPU) capable of executing software instructions.

16. The portable display of claim 15 wherein the portable display lacks a motherboard, lacks memory and lacks a disc drive.

17. The portable display of claim 14 further comprising:
a universal hinge, wherein the base is attached to the monitor with the universal hinge, wherein the universal hinge allows the monitor to be converted between a laptop type of position and a tablet computer type of position with respect to the base.

18. The portable display of claim 15 wherein the portable display lacks any input device.

19. The portable display of claim 1 further wherein the video screen is a touch screen.

20. A method of using a portable display comprised of a monitor and a base comprising:
choosing at least one of a group of: placing the monitor and the base in a closed laptop position, placing the monitor and the base in an open laptop position, placing the monitor and the base in a tablet computer position and placing the monitor and the base in the freestanding position;
placing the monitor and the base in the chosen position; and
wherein the portable display lacks a processor executing software instructions.

21. The method of claim 20 further comprising:
connecting the portable display to a primary computer, wherein the primary computer provides image data to the portable display.

22. The method of claim 20 further comprising:
entering numerical data through a keypad, wherein the portable display lacks alphabetical keys.
